(19) United States
(12) Patent Application Publication
(10) Pub. No.: US 2005/0107049 A1
(43) Pub. Date: May 19, 2005

(54) Method and device for generating a high frequency multi-carrier signal

(75) Inventors: Olaf Albert, Vienna (AT); Janos Gila, Moedling (AT)

Correspondence Address: SUGHRUE MION, PLLC, 2100 PENNSYLVANIA AVENUE, N.W., SUITE 800, WASHINGTON, DC, 20037, US

(73) Assignee: SIEMENS AKTIENGESELLSCHAFT

(21) Appl. No.: 10/898,591

(22) Filed: Jul. 26, 2004

Related U.S. Application Data
(63) Continuation of application No. PCT/DE03/00132, filed on Jan. 17, 2003.

(30) Foreign Application Priority Data
Jan. 25, 2002 (DE) 102 029 00.8

(51) Int. Cl. H04B 1/02; H04B 1/04; H04B 1/69; H04B 1/707; H04B 1/713

(52) U.S. Cl. 455/103; 455/114.2

(57) ABSTRACT

A circuit (SA) for generating a high-frequency multi-carrier signal (TS) from at least two carrier signals (S1, S2) having respective carrier frequencies (f1, f2). The circuit includes two signal generators (G1, G2) to generate the carrier signals, two high-frequency amplifiers (V1, V2), connected to outputs of the two signal generators respectively, to generate two amplified carrier signals (VS1, VS2) and a high-frequency combiner (HF) connected to the outputs of the amplifiers, to combine the two amplified carrier signals and generate the multi-carrier signal. The two carrier signals have a selected frequency spacing (dF) between them. The ratio of the frequency spacing of the two carrier signals to a frequency of each of the two carrier signals is less than 1:100. Electrical characteristics of the two amplifiers and the combiner are adjusted such that intermodulation frequency components of the two carrier signals have signal strengths below a certain threshold relative to signal strengths of the two carrier signals.

This is a Continuation of International Application PCT/DE03/00132, with an international filing date of Jan. 17, 2003, which was published under PCT Article 21(2) in German, and the disclosure of which is incorporated into this application by reference.

### FIELD AND BACKGROUND

The invention relates to a method and a circuit arrangement for generating a high-frequency multi-carrier signal from at least two carrier signals, each having a respective carrier frequency. The invention further relates to a read/write device equipped with such a circuit arrangement and to an identification system with at least one such read/write device and at least one mobile data memory.

Identification systems having one or more stationary read/write devices for remote exchange of data with mobile data memories over a, typically, radio-based data transmission link are known in the art. Such systems are used in technical installations in which various quantities of goods must be moved quickly and flexibly. The goods to be moved could include, for example, packages in a shipping installation, assembly parts in a production plant, luggage in a transportation system, etc.

One example of such an identification system is described in the ISO/IEC JTC 1/SC 31 WG4 Draft Standard entitled “Radiofrequency Identification Standard for Item Management—Air Interface, (WD 18000) dated Aug. 15, 2001. According to this draft standard, a read/write device polls for the presence of a mobile data memory within a detection range. To accomplish the detection, the read/write device emits an unmodulated first carrier signal with a defined carrier frequency, e.g., with a frequency of 2.45 GHz. A mobile data memory located within the detection range passively returns this carrier signal to the read/write device. The returning is done, for example, using back scattering.

Independently thereof, the mobile data memory modulates the impedance of a transmitting/receiving antenna integrated into the mobile data memory in cyclic sequences with a significant recognition sequence. This recognition sequence is representative of the mobile data memory and is used to identify it.

If the read/write device can receive the returned first carrier signal modulated with the recognition sequence, it attempts to validate it. If the recognition sequence is determined to be valid, the read/write device applies an additional carrier signal. By applying the second carrier signal, the read/write device indicates to the mobile data memory that a data transmission will follow. The second carrier signal is thus modulated for the data transmission. The mobile data memory cyclically polls for presence of the second carrier signal at short intervals. If the second carrier signal is detected to be present, the mobile data memory switches on the data receiver for the subsequent data transmission.

The frequencies of the second carrier signal and the first carrier signal typically differ by a fixed magnitude. The aforementioned standard proposes, for example, a frequency spacing of 10.6496 MHz. However, generating the two carrier signals whose frequencies differ by a magnitude as small as 10.7 MHz for carrier frequencies of approximately 2.45 GHz is technically complex.

For example, in the aforementioned 2.5 GHz ISM frequency band, governmental regulations related to transmission in radio frequencies must be taken into account. These regulations may require a minimum attenuation of the frequency bands adjacent to the two carrier frequencies, in order to avoid interference. A typical value for this minimum attenuation is, for example, 40 dB or—relative to the emitted maximum absolute power—e.g., a value of −30 dBm.

In some conventional circuits, the individual high-frequency carrier frequencies are each produced by a signal generator and are combined into a multi-carrier signal using an HF combiner or an HF divider known, for example, from microwave or satellite technology. Thereafter, the multi-carrier signal is amplified to the required output power by a power amplifier and fed to an antenna for transmission. As an alternative thereto, the multi-carrier signal can also be fed to a transmission line, e.g., a coaxial line.

The technical handbook entitled “Satellite Communications” by Dennis Roddy, Second Edition, McGraw-Hill 1995, ISBN 0-07-053370-9, for example, describes a circuit on pp. 209ff. Here, a plurality of microwave carrier signals are combined by means of an HF combiner. The combined multi-carrier signal is then amplified by a power amplifier and fed to a satellite antenna for transmission.

As a rule, when HF amplifiers are used in conventional arrangements, high-frequency parasitic components would occur in the amplified multi-carrier signal. This would be the case, in particular, if the individual carrier frequencies were especially “close” to each other in the frequency spectrum. Such parasitic frequency components, hereinafter referred to as intermodulation frequency components, are caused by errors in the transmission behavior of the HF amplifiers used.

While it is possible to reduce these intermodulation frequency components by using high quality amplifiers, for example, highly linear HF amplifiers, it is often complex and costly to do so. In addition, the use of such highly linear HF amplifiers result in high power consumption which also result in high heat dissipation. They also require considerable additional space. Further, it often becomes necessary, in spite of this, to connect costly and bulky HF filters on the output side, in order to reduce the intermodulation frequency components to a sufficient degree.

### SUMMARY

Conventional art does not provide a circuit for generating a high-frequency multi-carrier signal capable of using lower quality and less costly components, while also, in some cases, eliminating the need for downstream HF filtering. In addition, the conventional art does not provide such a circuit which additionally requires less space and consumes less power. Furthermore, a read/write device equipped with such a circuit is also not known.

At least some of the disadvantages in the conventional art are overcome by the disclosed teachings, an aspect of which is a circuit for generating a high-frequency multi-carrier signal from at least two carrier signals, each of which has a respective carrier frequency. The generated carrier signals are amplified separately from one another at the carrier signals can be generated such that the respective carrier frequencies have a selected frequency spacing relative to one another. The ratio of the frequency spacing of the two carrier signals to the frequency of one of the two carrier signals can be made less than 1:100. The carrier signals can also be generated in such a way that at least one carrier frequency has at least one sideband. It is also possible to generate carrier frequencies of at least 300 MHz. The innovations disclosed here can be used in an ISM frequency band of 2.45 GHz, 5.6 GHz or in an UHF frequency band of the ISM frequency band.

Circuits embodying the disclosed innovations include two signal generators to generate the carrier signals, two HF amplifiers connected to outputs of the two signal generators respectively to produce two amplified carrier signals, and an HF combiner connected to the output of the HF amplifier, to combine the two amplified carrier signals and output the multi-carrier signal.

According to further aspects and enhancements, in such a circuit, the signal generators can be adjusted such that the corresponding carrier frequencies have a selected frequency spacing relative to one another. The ratio of the selected frequency spacing to one of the carrier frequencies can be less than 1:100. The signal generators in the circuit arrangement can also be adjusted such that at least one carrier frequency has at least one sideband. In this circuit arrangement, the HF amplifiers and the HF combiner have electrical characteristics that are mutually adjusted in such a manner that intermodulation frequency components are attenuated by at least a predefined amount relative to the carrier frequencies when the multi-carrier frequency signal is formed. A non-linearity or a harmonic factor of an HF amplifier may serve, e.g., as the adjustable electrical characteristic. Also, a common mode rejection of the inputs of the HF combiner may serve as the adjustable electrical characteristic.

The attenuation can be 40 dB, or −30 dBm relative to the maximum absolute power output. Moreover, the carrier frequencies generated by the signal generators can be at least 300 MHz. The HF combiner in the circuit arrangement can be, e.g., a Wilkinson divider or a branch line divider. Such circuits can be operated, e.g., in an ISM frequency band of 2.45 GHz, 5.6 GHz or in an UHF frequency band of the ISM frequency band.

Another aspect of the disclosed teachings extends to a read/write device for data transmission having a circuit substantially as described above.

Yet another aspect of the disclosed teachings relates to an identification system having a mobile data memory and a read/write device substantially as described above.

In a specific enhancement, the identification system is based on an ISO/IEC 18000 Standard.

At least in some aspects of the disclosed teachings, it is possible to achieve sufficient attenuation between the carrier frequencies and the adjacent intermodulation frequency components in the multi-carrier signal without the use of highly linear HF amplifiers which are not only costly but also use more power and generate more heat.

Another associated benefit is increasing the reliability and service life of the circuit arrangement.

Further, a costly output-side HF filter may not be necessary to attenuate unacceptably high intermodulation frequency components that may otherwise be present in the multi-carrier signal.

Finally, such circuits may be adjusted by a suitable combination of the electrical characteristics of the HF amplifiers and the HF combiner, in such a manner that a sufficient attenuation is achieved even while the circuit complexity is kept relatively low.

### BRIEF DESCRIPTION OF THE DRAWINGS

The inventions will be explained in greater detail with reference to the following figures in which:

FIG. 1 shows an example of the structure of an identification system with a read/write device and, e.g., three mobile data memories, according to the invention,

FIG. 2 shows an example of a circuit arrangement, according to the invention, for generating a multi-carrier signal, and

FIG. 3-5 show frequency spectra of the carrier signals and the generated multi-carrier signal.

### DETAILED DESCRIPTION

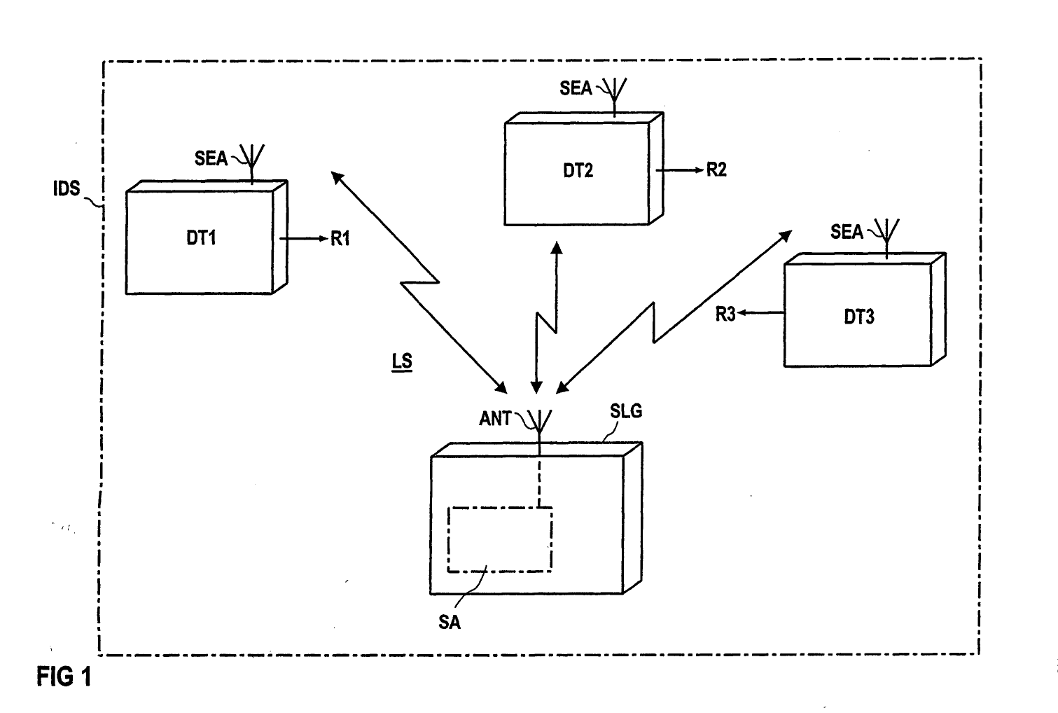

FIG. 1 shows an example of an identification system IDS with a stationary read/write device SLG according to the invention, which exchanges data with, e.g., three mobile data memories DT1-DT3. The mobile data memories DT1-DT3 move, e.g., in the directions R1-R3 as shown. The read/write device SLG has an antenna ANT to transmit/receive data. Likewise, the mobile data memories DT1-DT3 have suitable transmitting/receiving antennas SEA to transmit and receive the data. The example identification system includes a circuit SA, configured according to the invention, which forms part of the read/write device SLG and is connected to the transmitting/receiving antenna ANT for data transmission.

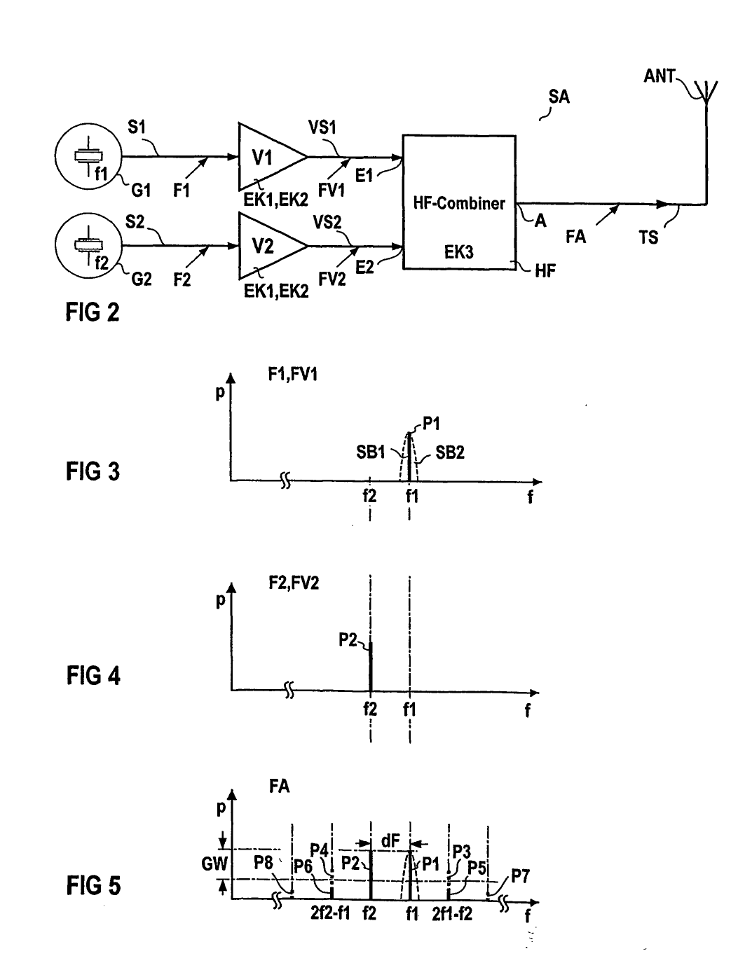

FIG. 2 shows an example of a circuit SA according to the invention. This circuit generates a multi-carrier signal TS using two high-frequency (HF) amplifiers V1, V2 and an HF combiner HF. The HF combiner could be, for example, a Wilkinson divider or a branch line divider. The two signal generators G1, G2 serve to generate carrier signals S1, S2, respectively, with respective carrier frequencies of f1, f2. The signal generators could be, for example quartz oscillators or HF synthesizers.

Each carrier signal S1, S2 is separately amplified to the desired power by means of HF amplifiers V1 and V2, respectively. The HF amplifiers are connected to the outputs of the signal generators at some appropriate downstream location. The output signals VS1 and VS2 of the HF amplifiers V1 and V2 are fed to E1 and E2, the input of the HF combiner HF. Because of such a combination of circuit elements, intermodulation with the respective carrier frequencies f1, f2 (as in at least some conventional arrangements) is avoided.

The HF combiner HF is connected and configured to combine the amplified carrier signals VS1, VS2 provided through the inputs E1, E2, respectively. At the signal output A of the HF combiner HF, the combined multi-carrier signal TS is made available. As shown in the example of FIG. 2, this combined multi-carrier signal can then be fed to the transmitting/receiving antenna ANT.

As explained above, the above-described conventional circuit arrangements require highly linear HF amplifiers to appreciably reduce the occurrence of intermodulation frequency components. These intermodulation frequency components are caused, in particular, by the non-linearity EK1 of the amplifier and/or the distortion factor EK2, which are so-called technical characteristics of the HF amplifier. The intermodulation frequency components are created at discrete points in the frequency spectrum of the multi-carrier signal, where they have a high noise level. The intermodulation frequency components occur at intervals that are multiples of the carrier frequency spacing dF on either side of the two carrier frequencies f1, f2. The farther they are from the carrier frequencies, the more attenuated they are (see FIG. 5). The lower the non-linearity EK1 or the distortion factor EK2 of the HF amplifier used is, the lower is the intensity of the noise level of the intermodulation frequency components.

Because of the structure of the embodiments described, technically simple and power-saving HF amplifiers V1, V2, having less stringent requirements with respect to the technical characteristics, such as non-linearities EK1 and/or distortion factor EK2, can be used. Significantly less space is also required and less heat is generated as a result of the power dissipation of the HF amplifiers V1, V2. This has the further advantage of increasing the reliability and service life of the circuit arrangement.

The structure of the described embodiment also makes it is possible to eliminate a costly HF filter on the output side, for attenuating unacceptably high intermodulation frequency components that might be present in the multi-carrier signal TS.

Intermodulation frequency components in the described structure can be produced only in the HF combiner HF through intermodulation of the amplified carrier signals VS1, VS2 present at the inputs E1, E2. A factor determining the possible creation thereof is the extent of signal separation of the signals VS1 and VS2 at the inputs E1, E2 on the HF combiner. Since an infinite signal separation is not technically feasible, intermodulation frequency components could therefore also occur in the HF combiner HF.

However, the intermodulation frequency components would occur only to a limited extent in the described embodiments, due to the simple structure of the HF combiner HF, frequency components, the component tolerances of the ohmic wave impedance and the accuracy of the geometric dimensions of the waveguides play a key role. These parameters determine the quality of the signal separation and/or the common mode rejection EK3 as a technical characteristic EK3 of the signals at the input E1, E2. The tolerances and accuracy described above can be reached at relatively low cost.

The HF amplifiers V1, V2 and the HF combiner HF can be appropriately selected for the inventive circuit SA, to provide an optimal solution, taking into account the relevant technical characteristics EK1-EK3. An optimal combination of characteristics can be selected in such a way that a required minimum limit GW for an attenuation of the intermodulation frequency components can be achieved without need to resort to additional HF filtering.

By way of further explanation, FIGS. 3 to 5 show the exemplary frequency spectra F1, F2, FV1, FV2, FA of the above-described carrier signals S1, S2 and the generated multi-carrier signal TS. The respective frequencies f1, f2 are plotted with the corresponding signal levels P1, P2 of the carrier frequencies f1, f2. In addition, for example, the carrier frequency f1 has sidebands SB1, SB2 due to data modulation. In these figures, the abscissa, labeled f, represents the frequency and the ordinate, labeled p, represents the level of the corresponding signals S1, S2, TS.

FIG. 3 shows the frequency spectrum F1, FV1 of the exemplary carrier signal S1 produced by the signal generator G1 and the amplified carrier signal VS1. Because intermodulation with the carrier frequency f2 is not possible, the frequency spectra F1, FV1 are nearly identical. Due to this fact, the two frequency spectra F1, FV1 are shown in the same figure.

FIG. 4 shows the frequency spectrum F2, FV2 of the carrier signal S2, analogously to the carrier signal S1, and the amplified carrier signal VS2. Here again, there is no data modulation.

FIG. 5 shows the exemplary frequency spectrum FA of the output signal A of the HF combiner HF after the two amplified carrier signals VS1, VS2 have been combined into the multi-carrier signal TS. The figure shows the above-described carrier frequencies f1, f2 with the carrier frequency spacing dF, as well as the intermodulation frequency components 2f2-f1, 2f1-f2, . . . having ever-decreasing levels in either direction along the frequency abscissa f.

The noise levels P3, P4, P7, P8 of the intermodulation frequency components 2f2-f1, 2f1-f2, . . . for a conventional circuit arrangement are illustrated by dash-dotted lines. It is evident that the exemplary noise levels P3, P4 are insufficiently attenuated relative to the two carrier frequencies f1, f2. Here, additional HF filtering measures would be necessary.

In contrast, with the use of the circuit arrangement according to the described embodiment of the invention, the intermodulation frequency components 2f-2-f 1, 2f1-f2 . . . have lower noise levels P5, P6 at the same frequencies. It is clear that the attenuation of the noise levels P5, P6 is greater than the required minimum attenuation GW relative to the two carrier frequencies f1, f2.

The described embodiments make it possible to achieve sufficient attenuation between the carrier frequencies and the adjacent intermodulation frequency components in the multi-carrier signal without the use of highly linear HF amplifiers which are not only costly but also use more power and generate more heat.

Further, the described embodiments help in increasing the reliability and service life of the circuit arrangement. Moreover, the described embodiments avoid the need for a costly output-side HF filter to attenuate unacceptably high intermodulation frequency components that may be present in the multi-carrier signal.

Further, the described embodiments provide an arrangement whereby the electrical characteristics of the HF amplifiers and the HF combiner can be selected and adjusted (tuned) in such a way that at least a sufficient amount of attenuation is achieved, even though the circuit complexity is, at the same time, greatly reduced.

The above description of the embodiments has been given by way of example. From the disclosure given, those skilled in the art will not only understand the present invention and its attendant advantages, but will also find apparent various changes and modifications to the structures and methods disclosed. It is sought, therefore, to cover all such changes and modifications as fall within the spirit and scope of the invention, as defined by the appended claims, and equivalents thereof.

1. A circuit for generating a high-frequency multi-carrier signal from at least two carrier signals having respective carrier frequencies of at least 300 MHz, wherein the at least two carrier signals have a selected frequency spacing relative to one another, and wherein a ratio of the selected frequency spacing to at least one of the carrier frequencies is less than 1:100, comprising:
two signal generators configured to generate, respectively, the two carrier signals;
two high-frequency amplifiers, connected, respectively, to outputs of the two signal generators; and
a high-frequency combiner connected to outputs of the amplifiers and configured to output the multi-carrier signal,
wherein electrical characteristics of the amplifiers and the combiner are adjusted such that intermodulation frequency components of the multi-carrier signal are attenuated by at least a predefined amount relative to the carrier frequencies.

2. The circuit of claim 1, wherein at least one of the signal generators is adjusted such that at least one of the carrier frequencies has at least one sideband.

3. The circuit arrangement of claim 1, wherein the adjusted electrical characteristics include a non-linearity of at least one of the amplifiers.

4. The circuit of claim 1, wherein the adjusted electrical characteristics include a distortion factor of at least one of the HF amplifiers.

5. The circuit of claim 1, wherein the adjusted electrical characteristics include a common mode rejection of inputs of the combiner.

6. The circuit of claim 1 wherein the pre-defined amount of the attenuation is at least 40 dB.

7. The circuit of claim 1, wherein the combiner is a Wilkinson divider.

8. The circuit of claim 1, wherein the combiner is a branch line divider.

9. The circuit of claim 1, configured to operate in an ISM frequency band of 2.45 GHz.

10. The circuit of claim 1, configured to operate in an ISM frequency band of 5.6 GHz.

11. The circuit of claim 1, configured to operate in a UHF frequency band of an ISM frequency band.

12. A read/write device (SLG) for data transmission comprising:
a circuit for generating a high-frequency multi-carrier signal from at least two carrier signals, including:
two signal generators configured to generate, respectively, the two carrier signals;
two high-frequency amplifiers, connected, respectively, to outputs of the two signal generators; and
a high-frequency combiner connected to outputs of the amplifiers and configured to output the multi-carrier signal,
wherein electrical characteristics of the amplifiers and the combiner are adjusted such that intermodulation frequency components of the multi-carrier signal are attenuated by at least a predefined amount relative to the carrier frequencies.

13. An identification system comprising:
a mobile data memory; and
a circuit for generating a high-frequency multi-carrier signal from at least two carrier signals, including:
two signal generators configured to generate, respectively, the two carrier signals;
two high-frequency amplifiers, connected, respectively, to outputs of the two signal generators; and
a high-frequency combiner connected to outputs of the amplifiers and configured to output the multi-carrier signal,
wherein electrical characteristics of the amplifiers and the combiner are adjusted such that intermodulation frequency components of the multi-carrier signal are attenuated by at least a predefined amount relative to the carrier frequencies.

14. The identification system of claim 13, based on an ISO/IEC 18000 Standard.

15. A method for generating a high-frequency multi-carrier signal, comprising:
generating two carrier signals with a selected frequency spacing between the two carrier signals and a ratio of the frequency spacing of the two carrier signals to a frequency of at least one of the two carrier signals being less than 1:100;
separately amplifying the two carrier signals using two amplifiers;
combining the two amplified carrier signals using a high-frequency combiner; and
tuning electrical characteristics of the two amplifiers and the combiner such that intermodulation frequency components of the two carrier signals have signal strengths below a given threshold relative to signal strengths of at least one of the two carrier signal frequencies.

16. The method according to claim 15, wherein the carrier signals have respective carrier frequencies of at least 300 MHz.
